(19) United States
(12) Patent Application Publication
(10) Pub. No.: US 2024/0405551 A1
(43) Pub. Date: Dec. 5, 2024

(54) BASE STATION MANAGEMENT DEVICE

(71) Applicant: NTT DOCOMO, INC., Tokyo (JP)

(72) Inventors: Masayasu SUMIYA, Chiyoda-ku (JP); Fumiaki IGARASHI, Chiyoda-ku (JP)

(73) Assignee: NTT DOCOMO, INC., Tokyo (JP)

(21) Appl. No.: 18/698,881

(22) PCT Filed: Sep. 7, 2022
(86) PCT No.: PCT/JP2022/033615

§ 371 Date: Apr. 5, 2024

(30) Foreign Application Priority Data
Oct. 29, 2021 (JP) 2021-177173

(51) Int. Cl. H02J 3/00; H04W 52/02

(52) U.S. Cl. CPC H02J 3/004; H04W 52/0206

(57) ABSTRACT

A base station management device (10) for managing at least one base station (20) including a solar power generation device (21) and a storage battery (22) and being capable of executing response to DR and self-wheeling of generated power includes: a power generation amount prediction unit (13) deriving a power generation amount prediction value of the base station at a prediction target time, based on a power generation amount actual value, weather information when the actual value has been obtained, and a weather forecast value of the prediction target time; and a schedule creation unit (14) that creates a schedule of self-wheeling of generated power based on the power generation amount prediction value of the base station, selects, in a case where a DR notification is given, one of the self-wheeling and the response to DR having a higher effect, and creates a schedule for implementing the method.

### TECHNICAL FIELD

The present disclosure relates to a base station management device that manages at least one solar power generation device-equipped wireless communication base station (that is, wireless communication base station (hereinafter, each abbreviated as a “base station” in this specification) in which a solar power generation device and a storage battery are incorporated) capable of executing both response to demand response (hereinafter also referred to as “DR”) and self-wheeling of generated power.

### BACKGROUND ART

In recent years, attention has been focused on the problem of environmental pollution associated with the use of fossil energy, an increase in carbon dioxide emissions, and the like, and attention has been paid to the utilization of renewable energy as one of the solutions. In particular, in the electric power sector, it is expected to appropriately adjust the balance between supply and demand of power by effectively utilizing generated power by adjusting not only the timing of power generation but also the timing of power consumption with both measures of demand response and self-wheeling. However, in a case where either the demand response or the self-wheeling is implemented in a base station capable of implementing both the measures of the demand response and the self-wheeling, it is necessary to select a measure to be implemented on that day as occasion arises.

### CITATION LIST

### Patent Literature

Patent Literature 1: Japanese Unexamined Patent Publication No. 2021-141769

### SUMMARY OF INVENTION

### Technical Problem

Patent Literature 1 discloses a power monitoring control device for self-wheeling of surplus generated power according to a planned value in order to prevent excessive imbalance of power when the power is self-wheeled. However, the technology disclosed in Patent Literature 1 may make it difficult to cope with a case where measures that can be implemented in a similar facility, such as response to demand response, occur at the same time. Further, in the technology disclosed in Patent Literature 1, the wheeling destination is fixed, and therefore, for example, the power consumption of the wheeling destination is small and the surplus generated power has to be discarded, which may cause an opportunity loss of utilization of the surplus generated power.

In view of the above circumstances, an object of the present disclosure is to determine which of the two measures of response to demand response and self-wheeling of generated power is effective in at least one base station capable of executing both the response to demand response and the self-wheeling of generated power, automatically create an effective control schedule, and reduce an opportunity loss of utilization of surplus generated power.

### Solution to Problem

A base station management device according to the present disclosure is a base station management device for managing at least one base station, the at least one base station including a solar power generation device and a storage battery and being capable of executing both response to demand response and self-wheeling of generated power, the base station management device including a power generation amount prediction unit configured to derive a power generation amount prediction value of the base station at a prediction target date and time based on a power generation amount actual value in the base station, weather information at a date and time when the power generation amount actual value has been obtained, and a weather forecast value at the prediction target date and time; and a schedule creation unit configured to: create a schedule of self-wheeling of generated power based on the power generation amount prediction value of the base station at the prediction target date and time derived by the power generation amount prediction unit and information on a power generation amount and a power consumption amount of the base station; select, in a case where a notification of demand response is given, as a method to be implemented, one of the self-wheeling and the response to the demand response having a higher effect based on a comparison between an effect in a case where the self-wheeling based on the created schedule is executed and an effect in a case where the response to the demand response is executed; and create a schedule for implementing the method.

In the base station management device, the power generation amount prediction unit derives a power generation amount prediction value of the base station at a prediction target date and time based on a power generation amount actual value in the base station, weather information at a date and time when the power generation amount actual value has been obtained, and a weather forecast value at the prediction target date and time. Then, the schedule creation unit creates a schedule of self-wheeling of generated power based on the power generation amount prediction value of the base station at the prediction target date and time derived by the power generation amount prediction unit and information on a power generation amount and a power consumption amount of the base station. Thereafter, in a case where a notification of demand response is given, the schedule creation unit selects, as a method to be implemented, one of the self-wheeling and the response to the demand response having a higher effect based on a comparison between an effect in a case where the self-wheeling based on the created schedule is executed and an effect in a case where the response to the demand response is executed, and creates a schedule for implementing the method. In this manner, it is possible to determine which of the two measures of response to demand response and self-wheeling of generated power is effective in at least one base station capable of executing both the response to demand response and the self-wheeling of generated power, automatically create an effective control schedule, and reduce an opportunity loss of utilization of surplus generated power.

### Advantageous Effects of Invention

According to the present disclosure, it is possible to determine which of the two measures of response to demand response and self-wheeling of generated power is effective in at least one base station capable of executing both the response to demand response and the self-wheeling of generated power, automatically create an effective control schedule, and reduce an opportunity loss of utilization of surplus generated power.

### BRIEF DESCRIPTION OF DRAWINGS

FIG. 1 is a configuration diagram of a wireless communication system according to first to third embodiments.

FIG. 2 is a flowchart illustrating processing executed in a wireless communication system.

FIG. 3(a) is a diagram for explaining data collection from a weather observation point, and FIG. 3(b) is a diagram for explaining a case where no weather observation point exists within a collection range.

FIG. 4(a) is a diagram for explaining machine learning related to prediction of power generation amount, and FIG. 4(b) is a diagram for explaining prediction using a machine learning model.

FIG. 5(a) is a graph illustrating a power generation amount prediction value and the like in a base station A of the first embodiment, FIG. 5(b) is a graph illustrating a power generation amount prediction value and the like in a base station B of the first embodiment, and FIG. 5(c) is a graph illustrating a power generation amount prediction value and the like in a base station C of the first embodiment.

FIG. 6 is a diagram for explaining a method of selecting a base station corresponding to DR.

FIG. 7 is a diagram for explaining exclusion of a base station in the second embodiment.

FIG. 8(a) is a graph illustrating a power generation amount prediction value and the like in a base station A of the third embodiment, FIG. 8(b) is a graph illustrating a power generation amount prediction value and the like in a base station B of the third embodiment, and FIG. 8(c) is a graph illustrating a power generation amount prediction value and the like in a base station C of the third embodiment.

FIG. 9 is a flowchart illustrating processing related to schedule creation in the third embodiment.

FIG. 10 is a diagram illustrating an example of the hardware configuration of a base station management device.

### DESCRIPTION OF EMBODIMENTS

Hereinafter, various embodiments of a base station management device according to the present disclosure will be described with reference to the drawings. Hereinafter, three embodiments will be described, and first, outlines thereof will be described. A first embodiment is an embodiment in which the basic form of the base station management device according to the present disclosure is described, a second embodiment is an embodiment in which a base station in an area corresponding to a weather pattern for which prediction of an amount of power generated by solar power is likely to fail is excluded from base stations for which a schedule of self-wheeling is created, and a third embodiment is an embodiment in which, in creation of a schedule of self-wheeling, settings for pairing between a transmitting base station and a receiving base station for surplus generated power are changed at any time interval such that a period during which self-wheeling is not performed is minimized.

### First Embodiment

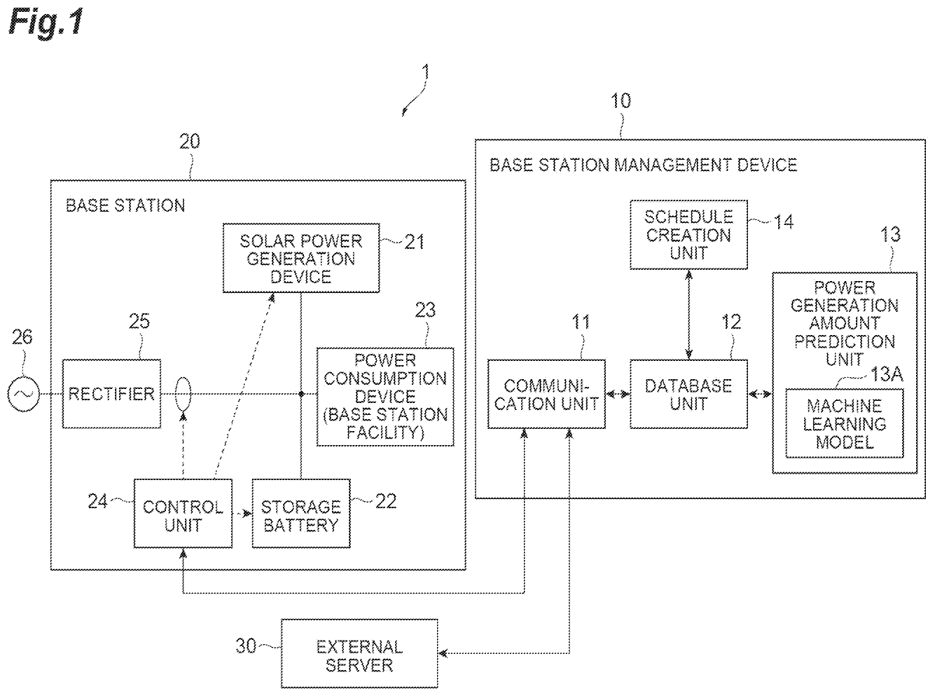

FIG. 1 illustrates a configuration of a wireless communication system 1 including a base station management device 10 according to the present disclosure, at least one solar power generation device-equipped wireless communication base station (each abbreviated as a “base station” in this specification) 20 to be managed by the base station management device 10, and at least one external server 30. Although only one base station 20 and only one external server 30 are illustrated in FIG. 1, a plurality of base stations 20 and a plurality of external servers 30 may be provided. The base station 20 includes a solar power generation device 21, a storage battery 22, a power consumption device (base station facility) 23, a rectifier 25, and a control unit 24 that controls operation of each structural element in the base station, and is configured to execute both response to demand response (DR) and self-wheeling of generated power. The base station 20 is configured such that any one of (1) DC power supplied from a commercial power supply 26 of system power and rectified by the rectifier 25, (2) power generated by the solar power generation device 21 (also referred to as “solar photovoltaic power”), and (3) power discharged from the storage battery 22 is supplied to the power consumption device 23, and the power supply operation is controlled by the control unit 24. In the base station 20 of FIG. 1, a solid line indicates a power supply line, and a broken line indicates a control signal line. The control unit 24 of the base station 20 provides the base station management device 10 with information on power generation amount (for example, power generation amount actual value) and information on power consumption amount (for example, power consumption amount actual value) in the base station 20, and the external server 30 provides the base station management device 10 with notification information on demand response and weather information (for example, past weather information and future weather forecast values).

The base station management device 10 includes a communication unit 11, a database unit 12, a power generation amount prediction unit 13, and a schedule creation unit 14. Among them, the communication unit 11 is a functional unit that acquires the information on power generation amount and the information on power consumption amount in the base station 20, and the notification information on demand response and the weather information provided by the external server 30, and transmits a control signal to the control unit 24 of the base station 20 and the external server 30.

The database unit 12 is a database that stores various information acquired by the communication unit 11, a power generation amount prediction value of the base station 20 obtained in prediction processing by the power generation amount prediction unit 13 to be described later, schedule information created by the schedule creation unit 14 to be described later, and the like.

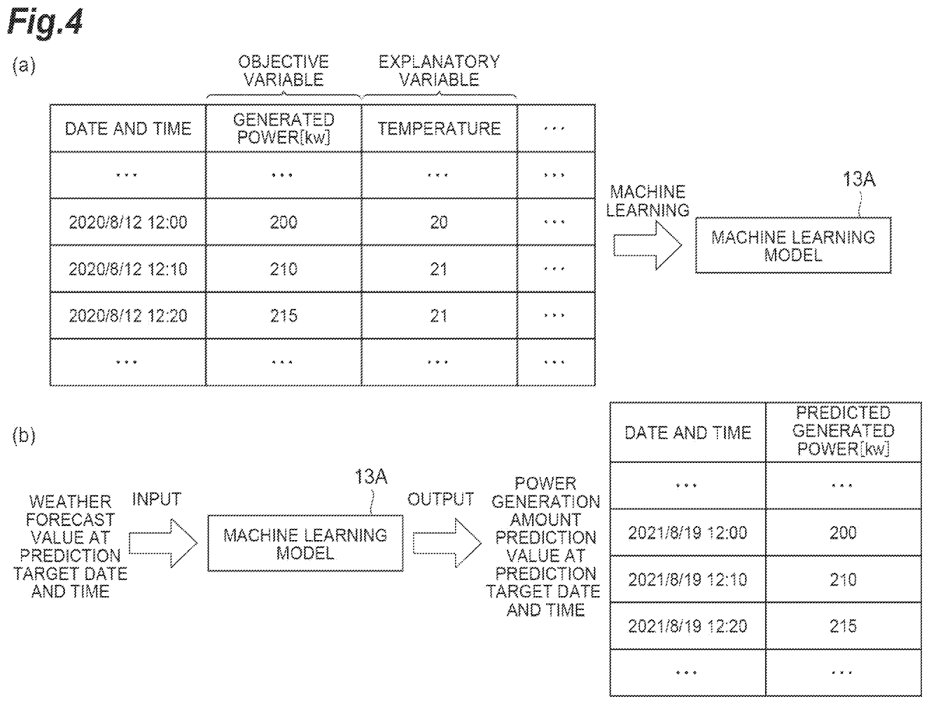

The power generation amount prediction unit 13 is a functional unit that derives a power generation amount prediction value of the base station 20 at a prediction target date and time based on a power generation amount actual value at the base station 20, weather information at a date and time when the power generation amount actual value has been acquired, both of which have been acquired by the communication unit 11, and a weather forecast value at the prediction target date and time. Further, as illustrated in FIG. 4(a), the power generation amount prediction unit 13 implements machine learning with the power generation amount actual value of the base station 20 used as an objective variable and the weather information at the date and time when the power generation amount actual value has been acquired used as an explanatory variable, thereby generating a machine learning model 13A to store the same in the power generation amount prediction unit 13. Note that although FIG. 4(a) illustrates temperature as an example of the weather information, and the weather information broadly includes, for example, temperature, humidity, weather type (sunny, cloudy, light rain, heavy rain, and so on), precipitation, and probability of precipitation.

The schedule creation unit 14 is a functional unit that creates a schedule of self-wheeling of the generated power based on the power generation amount prediction value in the base station 20 at the prediction target date and time which is derived by the power generation amount prediction unit 13, and the information on power generation amount (e.g., the power generation amount actual value) and the information on power consumption amount (e.g., the power consumption amount actual value) in the base station 20 which are acquired by the communication unit 11. Further, the schedule creation unit 14 has a function of selecting, when receiving a notification of demand response via the communication unit 11, as a method to be implemented, one of the self-wheeling and the response to the demand response having a higher economic effect by comparing an economic effect in a case where the self-wheeling based on the created schedule is executed and an economic effect in a case where the response to the demand response is executed, and creating a schedule for implementing the method.

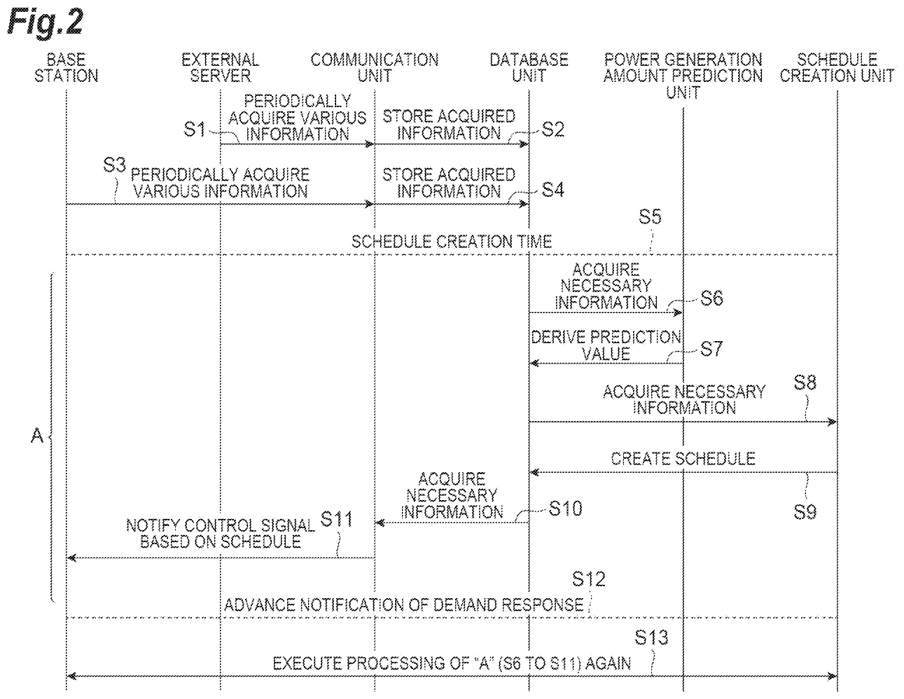

Next, processing to be executed in the wireless communication system 1 of FIG. 1 will be described with reference to the flowchart of FIG. 2. The communication unit 11 of the base station management device 10 periodically acquires weather information (such as past weather information and future weather forecast values) from the external server 30 (Step S1), and stores the acquired information in the database unit 12 (Step S2). The communication unit 11 receives notification information on demand response from the external server 30 as needed, although the notification information is not acquired periodically. Processing following the receipt of the notification of demand response will be described later in Steps S12 to S13. In addition, the communication unit 11 periodically acquires (Step S3) the power generation amount actual value as the information on power generation amount in the base station 20, the power consumption amount actual value as the information on power consumption amount in the base station 20, and the weather information at the point in time (the point in time when the power generation amount actual value is obtained), and stores the acquired information into the database unit 12 (Step S4).

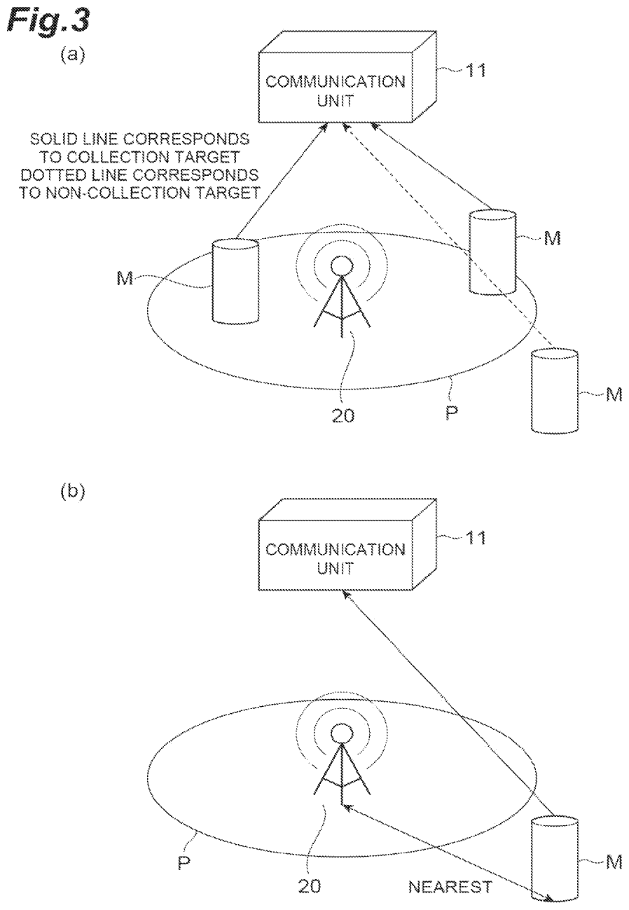

Supplementary information on the acquisition of the weather information by the communication unit 11 with reference to FIGS. 3(a) and 3(b) is as follows. For example, the weather information is collected for each base station 20. As illustrated in FIG. 3(a), a weather observation point M (connected to the communication unit 11 by a solid line) located inside a predetermined collection range P centered on the base station 20 is set as a target from which the weather information is collected, and a weather observation point M (connected to the communication unit 11 by a dotted line) located outside the collection range P is not set as the target from which the weather information is collected. The average of the weather information collected for each base station 20 is taken and the like, and the resultant is set as weather information related to the base station 20, and training data (objective variable and explanatory variable) to be used for prediction to be described later is created by combining the power generation amount actual value of the base station 20 and the weather information.

On the other hand, as illustrated in FIG. 3(b), in a case where no weather observation point M exists inside the collection range P centered on the base station 20, the weather information at the point in time (the point in time when the power generation amount actual value is obtained) at a weather observation point M nearest from the base station 20 is collected, and training data (objective variable and explanatory variable) to be used for prediction to be described later is created by combining the power generation amount actual value of the base station 20 and the collected weather information.

Thereafter, when a predetermined schedule creation time is reached (Step S5), the power generation amount prediction unit 13 acquires, as information necessary for prediction, the power generation amount actual value of the base station 20, the weather information at the date and time when the power generation amount actual value has been obtained, and a weather forecast value at the prediction target date and time from the database unit 12 (Step S6), and implements machine learning using the power generation amount actual value of the base station 20 as the objective variable and the weather information at the date and time when the power generation amount actual value has been obtained as the explanatory variable, thereby further training the built-in machine learning model 13A. Further, as illustrated in FIG. 4(b), the power generation amount prediction unit 13 inputs the acquired weather forecast value at the prediction target date and time to the machine learning model 13A to thereby derive the power generation amount prediction value in the base station 20 at the prediction target date and time, and stores the derived value into the database unit 12 (Step S7). As the prediction method, a machine learning model effective for time-series data, such as long short term memory (LSTM) or convolution LSTM, can be used. Note that it is not essential to further train the machine learning model 13A described above every time before deriving the prediction value, and such further training may be implemented at a lower frequency.

Next, the schedule creation unit 14 acquires (Step S8), from the database unit 12, information on the power generation amount prediction value in the base station 20 at the prediction target date and time which is derived by the power generation amount prediction unit 13, and the power generation amount actual value as well as the power consumption amount actual value of the base station 20, creates a schedule of self-wheeling of generated power based on the acquired information as described later, and stores the schedule into the database unit 12 (Step S9). Then, the communication unit 11 acquires, from the database unit 12, information on the stored schedule of self-wheeling of generated power (Step S10), and notifies the control unit 24 in the base station 20 of a control signal based on the schedule of self-wheeling (Step S11). As a result, the base station 20 performs self-wheeling according to the schedule of self-wheeling.

With respect to the creation of the schedule of self-wheeling in Step S9, the schedule creation unit 14 creates the schedule of self-wheeling as described below, for example, so as to maximize the self-consumption amount of the generated power in the entire at least one base station to be managed. The schedule creation unit 14 calculates, for each base station 20, the amount of power to be purchased from the system power at each time based on the power generation amount prediction value and the power consumption amount actual value. At this time, since the daily power consumption does not greatly fluctuate in each base station 20, it is not necessary to perform advanced prediction of power consumption amount, and the “power consumption amount actual value of the previous day” in the same time zone is used as the “power consumption amount prediction value of the day”. However, this is merely an example, and the “power consumption amount prediction value of the day” may be derived using an existing power consumption amount prediction technique and used for creating a schedule. The schedule creation unit 14 selects, from among the base stations 20, a base station in which the amount of power to be purchased from a system power supply is 0. Since the base station 20 in which the amount of power to be purchased is 0 is a base station in which the power generated by solar power is surplus, the base station performs self-wheeling of the power to another base station that purchases power from the system power supply at the same timing. At this time, as a partner to be paired with the base station that performs self-wheeling, a base station that is expected to purchase more power than surplus generated power of the base station that performs the self-wheeling is selected.

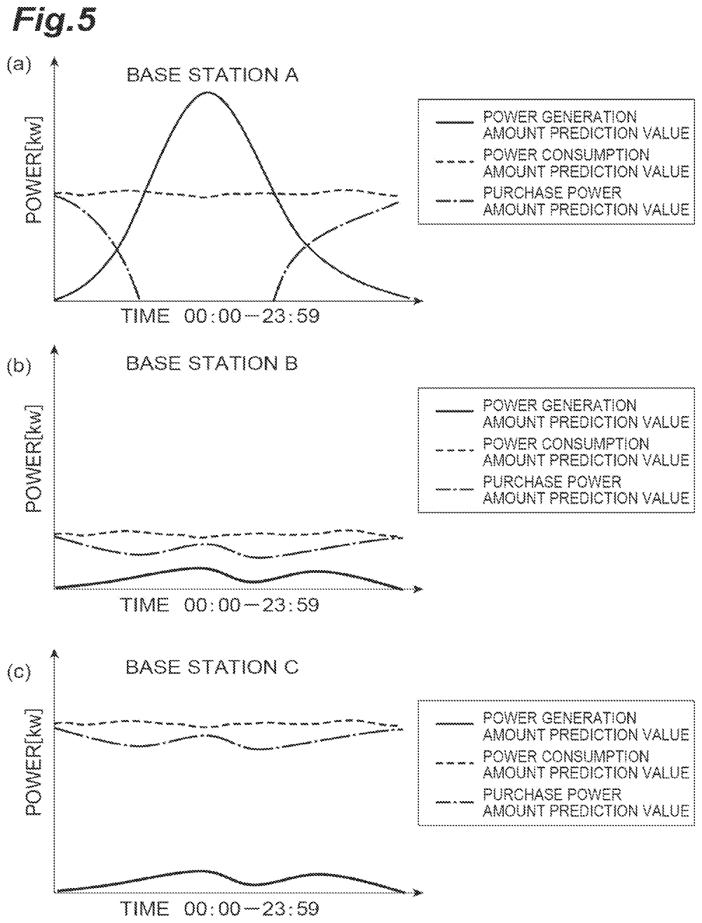

Further, pairing of a plurality of base stations in self-wheeling will be described. FIGS. 5(a) to 5(c) illustrate a power generation amount prediction value, a power consumption amount prediction value (here, for example, a power consumption amount actual value on the previous day in the same time zone), and a purchase power amount prediction value of each of the base stations A to C. As illustrated in FIG. 5(a), as a partner to be paired with the base station A that has surplus generated power and performs self-wheeling, a base station in which the purchase power amount prediction value (dashed-dotted line in FIG. 5(b)) is lower than the surplus generated power of the base station A, such as the base station B, is excluded from the selection target, and a base station in which the purchase power amount prediction value (dashed-dotted line in FIG. 5(c)) exceeds the surplus generated power of the base station A, such as the base station C, is selected as the partner to be paired with the base station A in the entire time zone in which the surplus generated power is generated in the base station A. In a case where there is no appropriate base station as the partner to be paired with the base station A, the schedule of self-wheeling of the base station A is not created, and the self-wheeling is not executed. This makes it possible to prevent the occurrence of a problem in a case where a base station with a small amount of power to be purchased is paired (for example, a problem of difficulty in effectively utilizing the surplus generated power and a problem of a penalty (an imbalance charge or the like) due to a failure to achieve predetermined power transfer).

Thereafter, when the advance notification of demand response is given (Step S12), the processing of Steps S6 to S11 is executed again (Step S13). On that occasion, in the processing of Step S9, the schedule creation unit 14 selects, as a method to be implemented, one of the self-wheeling and the response to the demand response having a higher economic effect by comparing an economic effect in a case where the self-wheeling based on the created schedule is executed and an economic effect in a case where the response to the demand response is executed, and creates a schedule for implementing the method.

The economic effect in the case of executing the self-wheeling and the economic effect in the case of responding to the demand response can be derived as follows, for example.

$$Economic effect of DR = D \times α - B \times c \qquad [ Equation 1 ]$$

D: remuneration for DR request [Yen]
α: DR success rate
B: power amount of storage battery used for DR [kWh]
c: unit price when power is purchased from system power [Yen/kWh]
Economic effect of self-wheeling=N×c−P×c′
N: amount of power to be purchased when self-wheeling is not executed [kWh]
c: unit price when power is purchased from system power [Yen/kWh]
P: power amount for self-wheeling when self-wheeling is executed [kWh]
c′: unit price of wheeling charge when self-wheeling is executed [Yen/kWh]

In the DR, the requested power amount and its unit price (kw/Japanese yen) are presented, and the above-described “remuneration D for the DR request” is obtained by multiplying them. A base station that can respond to the requested power amount is selected, an economic effect (Japanese yen) in a case where the selected base station responds to the DR request is compared with an economic effect in a case where the selected base station does not respond to the DR and performs self-wheeling according to the schedule, and the operation method is switched to an operation method with a higher economic effect. In a case where the selected base station responds to the DR request, the self-wheeling scheduled in the corresponding time zone is not executed in each of the base stations. The above equations are an example of an equation for calculating the economic effect in the case of responding to the DR request and the economic effect in the case of performing self-wheeling and are not limited to the content of the above equations. In addition, the comparison is not limited to the economic effect, and the comprehensive comparison may be made in consideration of an effect based on another viewpoint.

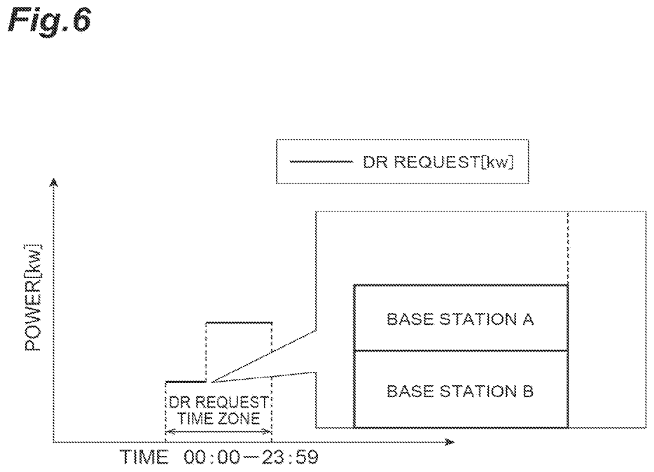

In the present embodiment, the base station responding to the DR request is not fixed, and the base station responding to the DR request is selected at any time interval. At this time, using the fact that the power consumption at the base station is almost constant at all times, for example, as illustrated in FIG. 6, in order to achieve the DR request, the base station responding to the DR request is selected by accumulating the substantial power consumption (amount obtained by subtracting the storage capacity from the power consumption) of the base station responding to the DR request. Therefore, the base station responding to the DR request is selected by solving the optimization problem as in the following formula.

$$maximize {\sum }_{i = 1}^{N} {x}_{i} {v}_{i} \qquad [ Equation 2 ]$$

$$subject to {\sum }_{i = 1}^{N} {w}_{i} - {v}_{i} ≦ W$$

$${x}_{i} ϵ \{ 0 , 1 \} ( i = 1 , ⋯ , N )$$

i: base station number
N: total number of base stations
Wᵢ: average of power consumption of base station [KW]
Vᵢ: stored power in base station [KW]
W: DR request amount in corresponding time zone [KW]

The DR success rate a in the equation provided earlier is calculated by, for example, simulating how many times DR was successfully performed among the cases where DR was performed at the same time in the past by the base station selected as described above. To be specific, it is calculated by dividing the number of times of DR success by the total number of times of DR was performed.

As described above, from among the self-wheeling and the response to the demand response, one having a higher economic effect is selected as a method to be implemented, and a control signal based on a schedule for implementing the selected method is notified from the communication unit 11 to the control unit 24 of the base station 20. As a result, in the base station 20, one of the self-wheeling and the response to the demand response having a higher economic effect is performed.

According to the first embodiment, it is possible to determine which of the two measures of response to demand response and self-wheeling of generated power is effective in at least one base station capable of executing both the response to demand response and the self-wheeling of generated power, automatically create an effective control schedule, and reduce an opportunity loss of utilization of surplus generated power.

### Second Embodiment

In the second embodiment, an example will be described in which a base station in an area corresponding to a weather pattern for which prediction of an amount of power generated by solar power is likely to fail is excluded from base stations for which a schedule of self-wheeling is created.

The schedule creation unit 14 in the second embodiment extracts, in Step S9 of FIG. 2, a weather pattern for which prediction of an amount of power generated by solar power is likely to fail, specifically, a weather pattern in which an error of a power generation amount prediction value exceeds a predetermined allowable standard (for example, cloudy or the like) by comparing a prediction result of a power generation amount in the past with an actual measured value thereof, and excludes a base station located in an area corresponding to the extracted weather pattern from base stations for which a schedule of self-wheeling is created. Whether the weather is prone to deterioration in prediction accuracy based on the past tendency can be determined by, for example, performing clustering such as k-means clustering on the weather data and comparing whether an average prediction error of a cluster to which the data of the day predicted on the day belongs exceeds a threshold arbitrarily set.

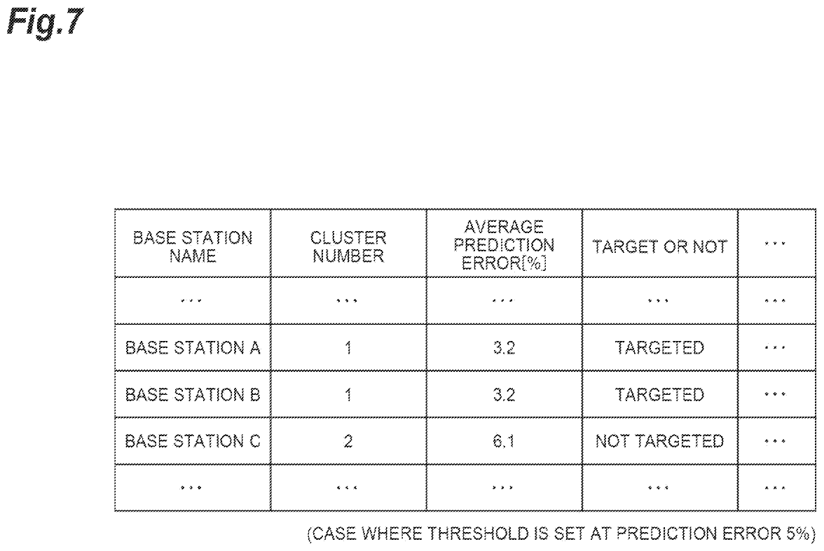

For example, as illustrated in FIG. 7, in a case where an average prediction error (%) of each of the base stations A to C is obtained and the threshold that is the predetermined allowable standard is set as the prediction error 5%, the average prediction error of the base stations A and B is equal to or less than the threshold (5%), but the average prediction error of the base station C exceeds the threshold (5%), and thus the base station C is excluded from base stations for which a schedule of self-wheeling is created.

According to the second embodiment described above, by excluding a base station in an area corresponding to a weather pattern for which prediction of a power generation amount is likely to fail from base stations for which a schedule of self-wheeling is created, it is possible to create a more appropriate schedule of self-wheeling after eliminating the influence of the prediction error of the power generation amount.

### Third Embodiment

In the third embodiment, an example will be described in which, in creation of a schedule of self-wheeling, settings for pairing between a transmitting base station and a receiving base station for surplus generated power are changed at any time interval such that a period during which self-wheeling is not performed is minimized.

The schedule creation unit 14 in the third embodiment changes, in creation of a schedule of self-wheeling in Step S9 of FIG. 2, the settings for pairing between the transmitting base station and the receiving base station for surplus generated power in the self-wheeling at any time interval such that the period in which the self-wheeling is not performed is minimized. This makes it possible to minimize the amount of power that cannot be self-wheeled and is discarded.

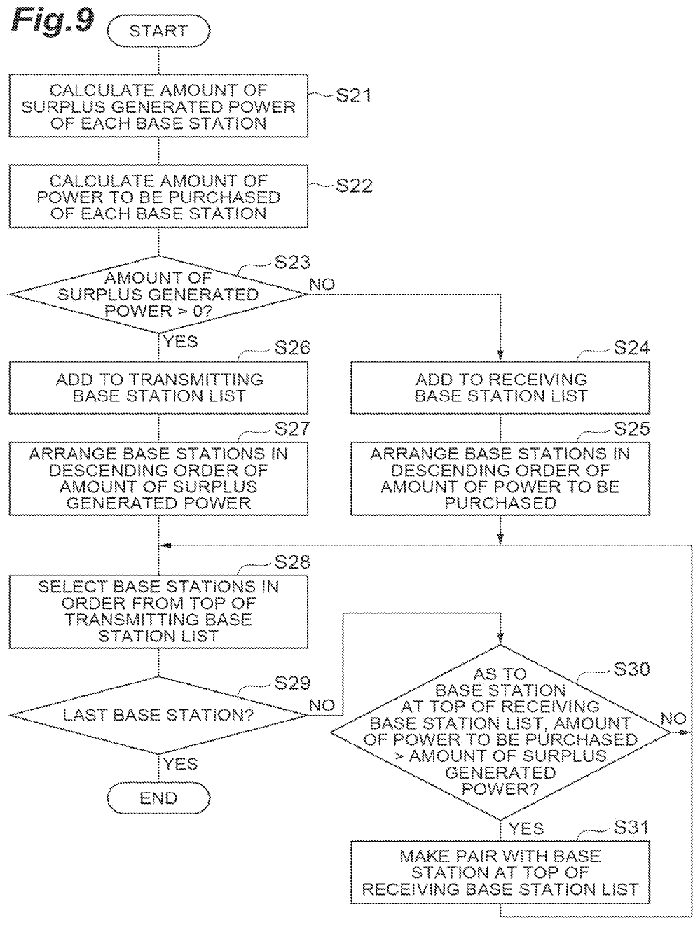

For example, by executing the processing illustrated in FIG. 9 at any time interval, the settings for pairing between the transmitting base station and the receiving base station for surplus generated power can be appropriately changed at any time interval. To be specific, the schedule creation unit 14 calculates an amount of surplus generated power of each base station (Step S21) and calculates an amount of power to be purchased of each base station (Step S22).

Then, the schedule creation unit 14 determines whether or not the amount of surplus generated power of each base station exceeds 0 (Step S23), adds a base station in which the amount of surplus generated power does not exceed 0 to a receiving base station list (Step S24), and arranges the base stations in descending order of the amount of power to be purchased in the receiving base station list (Step S25).

On the other hand, the schedule creation unit 14 adds a base station in which the amount of surplus generated power exceeds 0 determined in Step S23 to a transmitting base station list (Step S26), and arranges the base stations in descending order of the amount of surplus generated power in the transmitting base station list (Step S27).

Further, the schedule creation unit 14 selects the base stations in order from the top of the transmitting base station list (Step S28), if the selected base station (base station at the top of the transmitting base station list at the point in time) is not the last base station in the transmitting base station list (NO in Step S29), then the schedule creation unit 14 determines whether the amount of power to be purchased of the base station at the top of the receiving base station list exceeds the amount of surplus generated power of the selected base station (Step S30), and if the amount of power to be purchased of the base station at the top of the receiving base station list exceeds the amount of surplus generated power of the selected base station (YES in Step S30), then the schedule creation unit 14 pairs the selected base station (base station at the top of the transmitting base station list) with the base station at the top of the receiving base station list (Step S31). As a result, the base station having the largest amount of surplus generated power at the point in time and the base station having the largest amount of power to be purchased are paired, and thus effective pairing is realized, leading to the maximization of the economic effect by self-wheeling. Thereafter, the paired base station at the top of the transmitting base station list and the paired base station at the top of the receiving base station list are excluded from the lists, the processing returns to Step S28, the base station at the top of the transmitting base station list is selected newly, and the processing in Steps S29 to S31 is executed.

On the other hand, in Step S30, if the amount of power to be purchased of the base station at the top of the receiving base station list does not exceed the amount of surplus generated power of the selected base station (if NO in Step S30), then the pairing in Step S31 is not executed, and the unpaired base station at the top of the transmitting base station list is excluded from the list, the processing returns to Step S28, the base station at the top of the transmitting base station list is selected newly, and the processing in Steps S29 to S31 is executed.

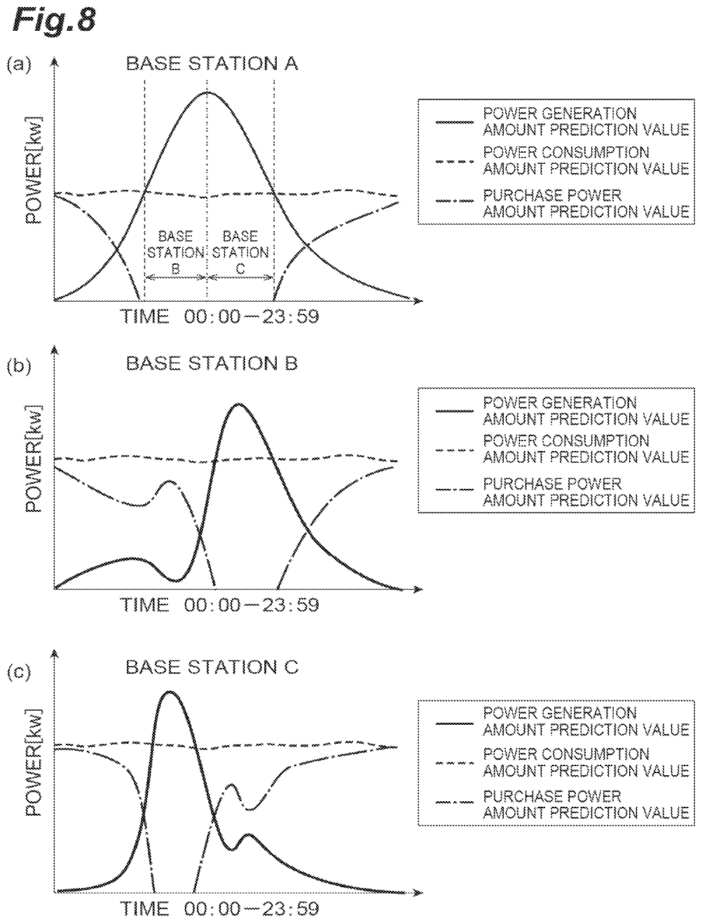

FIGS. 8(a) to 8(c) illustrate a power generation amount prediction value, a power consumption amount prediction value (here, for example, a power consumption amount actual value on the previous day in the same time zone), and a purchase power amount prediction value of each of the base stations A to C. As a partner to be paired with the base station A, the base station B is selected in a time zone T1 of FIG. 8(a), and the base station C is selected in the subsequent time zone T2. This is because, with respect to the base station A in which the surplus generated power is generated in the time zones T1 and T2, no power to be purchased is generated in the base station C (FIG. 8(c)) and power to be purchased is generated in the base station B (FIG. 8(b)) in the time zone T1, and thus the base station B is selected. On the other hand, in the time zone T2, no power to be purchased is generated in the base station B (FIG. 8(b)) and power to be purchased is generated in the base station C (FIG. 8(c)), and thus the base station C is selected.

According to the third embodiment as described above, by changing the partner to be paired with the base station having surplus generated power at any time interval as illustrated in the above drawings, it is possible to avoid a situation in which the surplus generated power is discarded without being able to be self-wheeled, and to minimize the amount of power to be discarded. Further, the base station having the largest amount of surplus generated power at the point in time and the base station having the largest amount of power to be purchased are paired, and thus effective pairing is realized, leading to the maximization of the economic effect by self-wheeling. Further, in Step S30, in a case where the amount of power to be purchased of the base station at the top of the receiving base station list does not exceed the amount of surplus generated power of the selected base station (the base station at the top of the transmitting base station list), it is possible to determine that, in the receiving base station list, there is only a base station having an amount of power to be purchased smaller than the amount of surplus generated power of the base station at the top of the transmitting base station list. Therefore, in such a situation, by avoiding the pairing in Step S31, it is possible to prevent the occurrence of a problem in a case where a base station with a small amount of power to be purchased is paired (for example, a problem of difficulty in effectively utilizing the surplus generated power and a problem of a penalty (an imbalance charge or the like) due to a failure to achieve predetermined power transfer).

### Terms, Modifications, and the Like

Note that the block diagrams used for explaining the embodiments illustrate blocks in units of functions. The functional blocks (configuration units) are implemented by an arbitrary combination of at least one of hardware and software. A method for implementing the functional blocks is not particularly limited. That is, each functional block may be implemented by using one physically or logically combined device, or may be implemented by directly or indirectly (for example, by using wired, wireless, or the like) connecting two or more physically or logically separated devices and using the plurality of devices. The functional block may be implemented by combining software with the one device or the plurality of devices.

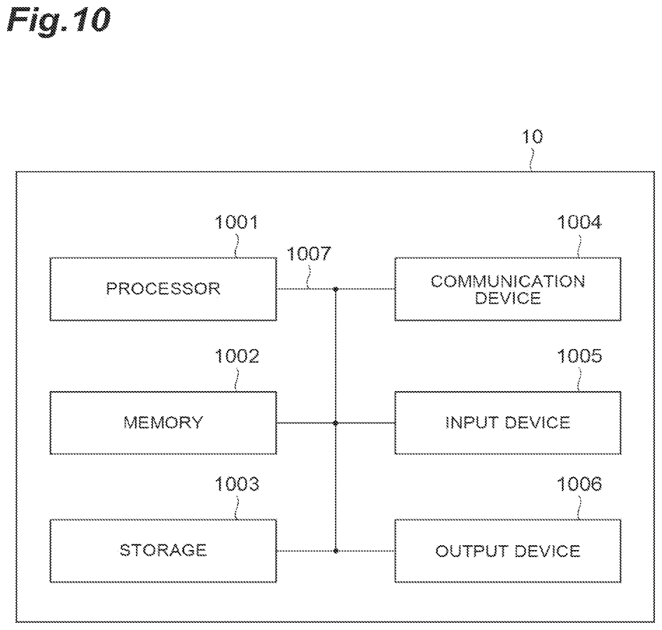

For example, the base station management device 10 may function as a computer that performs the processing in the embodiments. FIG. 10 is a diagram illustrating an example of the hardware configuration of the base station management device 10. The base station management device 10 may be physically configured as a computer device including a processor 1001, a memory 1002, a storage 1003, a communication device 1004, an input device 1005, an output device 1006, and a bus 1007.

In the following description, the term “device” can be read as a circuit, device, unit, or the like. The hardware configuration of the base station management device 10 may be configured to include one or a plurality of the devices illustrated in the drawings, or may be configured without some of the devices.

Each function in the base station management device 10 is implemented in response to the processor 1001 performing operation by loading predetermined software (program) on hardware such as the processor 1001 and the memory 1002, controlling communication by the communication device 1004, and controlling at least one of reading and writing of data in the memory 1002 and the storage 1003.

Although the present disclosure has been described in detail above, it is apparent to those skilled in the art that the present disclosure is not limited to the embodiments described in the present disclosure. The present disclosure can be implemented as modifications and variations without departing from the spirit and scope of the present disclosure defined by the claims. Therefore, the description of the present disclosure is for the purpose of illustration and does not have any restrictive meaning to the present disclosure.

The order of the processing procedure, sequence, flowchart, and the like of each aspect/embodiment described in the present disclosure may be changed to the extent that it is consistent. For example, as for the methods described in the present disclosure, elements of various steps are presented using an example order, and are not limited to the particular order presented.

The input/output information and the like may be stored in a specific location (memory, for example) or may be managed using a management table. The input/output information and the like can be overwritten, updated, or additionally written. The output information and the like may be deleted. The input information and the like may be transmitted to another device.

As used in this disclosure, the phrase “based on” does not mean “based only on” unless explicitly stated otherwise. In other words, the phrase “based on” means both “based only on” and “based at least on”.

In a case where the present disclosure uses the terms “include,” “including,” and variations thereof, these terms are intended to be inclusive in a manner similar to the term “comprising”. Further, the term “or” used in the present disclosure is intended not to be an exclusive OR.

In the present disclosure, for example, in a case where articles such as a, an, and the in English are added by translation, the present disclosure may include a case where a noun following these articles is a plural form.

In the present disclosure, the term “A and B are different” may mean “A and B are different from each other”. The term may mean that “A and B are different from C”. Terms such as “separated”, “coupled” and the like may also be interpreted in the same manner as “different”.

### REFERENCE SIGNS LIST

1: WIRELESS COMMUNICATION SYSTEM, 10: BASE STATION MANAGEMENT DEVICE, 11: COMMUNICATION UNIT, 12: DATABASE UNIT, 13: POWER GENERATION AMOUNT PREDICTION UNIT, 13A: MACHINE LEARNING MODEL, 14: SCHEDULE CREATION UNIT, 20: BASE STATION, 21: SOLAR POWER GENERATION DEVICE, 22: STORAGE BATTERY, 23: POWER CONSUMPTION DEVICE, 24: CONTROL UNIT, 25: RECTIFIER, 26: COMMERCIAL POWER SUPPLY, 30: EXTERNAL SERVER, 1001: PROCESSOR, 1002: MEMORY, 1003: STORAGE, 1004: COMMUNICATION DEVICE, 1005: INPUT DEVICE, 1006: OUTPUT DEVICE, 1007: BUS.

1. A base station management device for managing at least one base station, the at least one base station including a solar power generation device and a storage battery and being capable of executing both response to demand response and self-wheeling of generated power,
the base station management device comprising:
a power generation amount prediction unit configured to derive a power generation amount prediction value of the base station at a prediction target date and time based on a power generation amount actual value in the base station, weather information at a date and time when the power generation amount actual value has been obtained, and a weather forecast value at the prediction target date and time; and
a schedule creation unit configured to: create a schedule of self-wheeling of generated power based on the power generation amount prediction value of the base station at the prediction target date and time derived by the power generation amount prediction unit and information on a power generation amount and a power consumption amount of the base station; select, in a case where a notification of demand response is given, as a method to be implemented, one of the self-wheeling and the response to the demand response having a higher effect based on a comparison between an effect in a case where the self-wheeling based on the created schedule is executed and an effect in a case where the response to the demand response is executed; and create a schedule for implementing the method.

2. The base station management device according to claim 1,
wherein the power generation amount prediction unit derives the power generation amount prediction value of the base station at the prediction target date and time by implementing machine learning with the power generation amount actual value of the base station used as an objective variable and the weather information at the date and time when the power generation amount actual value has been obtained used as an explanatory variable to thereby generate a machine learning model, and by inputting the weather forecast value at the prediction target date and time to the machine learning model.

3. The base station management device according to claim 1,
wherein as for creation of the schedule of self-wheeling of generated power, the schedule creation unit creates the schedule of self-wheeling of generated power so as to maximize a self-consumption amount of generated power in an entire base station to be managed.

4. The base station management device according to claim 1,
wherein the schedule creation unit selects, in a case where the notification of the demand response is given, as a method to be implemented, one of the self-wheeling and the response to the demand response having a higher economic effect by comparing an economic effect in a case where the self-wheeling based on the created schedule is executed and an economic effect in a case where the response to the demand response is executed, and creates a schedule for implementing the method.

5. The base station management device according to claim 1,
wherein the schedule creation unit extracts a weather pattern in which an error of the power generation amount prediction value exceeds a predetermined allowable standard based on a prediction result of a past power generation amount, and excludes a base station located in an area corresponding to the extracted weather pattern from base stations for which a schedule of the self-wheeling is created.

6. The base station management device according to claim 1,
wherein the schedule creation unit changes, in creation of the schedule of self-wheeling of generated power, settings for pairing between a transmitting base station and a receiving base station for surplus generated power in the self-wheeling at any time interval such that a period in which the self-wheeling is not performed is minimized.

7. The base station management device according to claim 2,
wherein as for creation of the schedule of self-wheeling of generated power, the schedule creation unit creates the schedule of self-wheeling of generated power so as to maximize a self-consumption amount of generated power in an entire base station to be managed.
